(19) United States
(12) Patent Application Publication
(10) Pub. No.: US 2006/0203998 A1
(43) Pub. Date: Sep. 14, 2006

(54) Eyeglass-attached video display based on wireless transmission from a cell phone

(76) Inventor: Oded Ben-Arie, Bal Harbor, FL (US)

Correspondence Address: GIFFORD, KRASS, GROH, SPRINKLE & CITKOWSKI, P.C, PO BOX 7021, TROY, MI, 48007-7021, US

(21) Appl. No.: 11/371,036

(22) Filed: Mar. 8, 2006

Related U.S. Application Data
(60) Provisional application No. 60/659,480, filed on Mar. 8, 2005.

(51) Int. Cl. H04N 7/14; H04M 1/00

(52) U.S. Cl. 379/430; 348/14.01; 455/575.1

(57) ABSTRACT

A headset for use with a mobile phone incorporates a microphone, an earphone, and a video display adapted to be supported in the user's field of view. The headset is adapted for use with a cellular phone transported by the user in a pocket, purse, belt holster or simply in the user's hand, out of the view of the user. A wireless communication link transmits the signal currently being shown on the screen of the cellular phone to the screen of the headset-attached display so that the user can visualize the current display without viewing the cellular phone. The wireless communication may be bidirectional, allowing command signals generated at the headset either by depressing contacts on the headset or by voice command signals issued by the operator which are decoded into operational commands either at the headset or the cellular phone. The display may be supported by the user's eyeglasses or physically attached to the headset.

### RELATED APPLICATION

This application claims priority of U.S. Provisional Patent Application Ser. No. 60/60/659,480 filed Mar. 8, 2005, which is incorporated herein by reference.

### FIELD OF THE INVENTION

This invention relates to a headset for use with a cellular phone, incorporating a microphone, an earphone, any of video display, and to a wireless communication system that is adapted to transmit the display of the cell phone to the display of the headset.

### BACKGROUND OF THE INVENTION

Headsets including earphones and a microphone are commonly used with cell phones. Most cell phone units have a port which allows a connector formed at the end of a wire extending from the headset to be plugged into the cell phone. This allows the cell phone user to communicate over the cell phone without the necessity of holding the cell phone to the user's head. The cell phone can be carried in the user's pocket or pocketbook or held in the user's hand, remotely from the head, while the user carries on a conversation over the cell phone. One of the advantages of the headset being remote from a cell phone located in the user's hand or pocket is that the high frequency transmissions from the cell phone are nowhere near the user's head, eliminating the fear that this radiation may cause brain tumors or other physiological changes in the user.

In order to eliminate the need for the wire connecting the headset to the cell phone, several wireless, bidirectional transmission schemes have been used. One uses the “Bluetooth” short range wireless system to connect the headset to the cell phone. Other RF systems allow a larger degree of separation between the cell phone and the headset. With these wireless interconnections the cell phone may be carried in a pocket and the communication is done strictly through the headset. The headset may include a start/stop button or the like.

Modern cell phones often employ a video screen for displaying information supported within the cell phone, such as phone lists, menu arrangements and the like. Additionally, it is becoming increasingly common to transmit video images to cell phones over a cellular network. These images may comprise still pictures, video clips, digital data in the form of information available on the Internet, or the like. With the present wireless headsets it is necessary for the user to bring the cell phone close to the user's head to view these images.

### BRIEF DESCRIPTION OF THE DRAWINGS

FIG. 1 is an illustration of the headset display system of the present invention as displayed in use; and

FIG. 2 is a detailed illustration of a headset display of the present invention.

### DETAILED DESCRIPTION OF THE INVENTION

The present invention is accordingly directed toward a headset which incorporates some form of video display. The display is connected to a cell phone by a communication link which may take the form of a wire but is preferably a wireless link. The wireless link between the headset and the cell phone transmits data representing an image or a digital representation of the display to be generated on the headset, which would otherwise appear on the video screen of the cell phone. The video display provided to the user of the system may either be clipped to eyeglasses worn by the user or it may be attached directly to the headset, which is supported on the user's head either by a head strap or by engagement with the user's ear. The display preferably appears visible to the user in such a way that it does not interfere with the user's usual vision. It may take the form of a small video screen, or it may be projected onto an eyeglass.

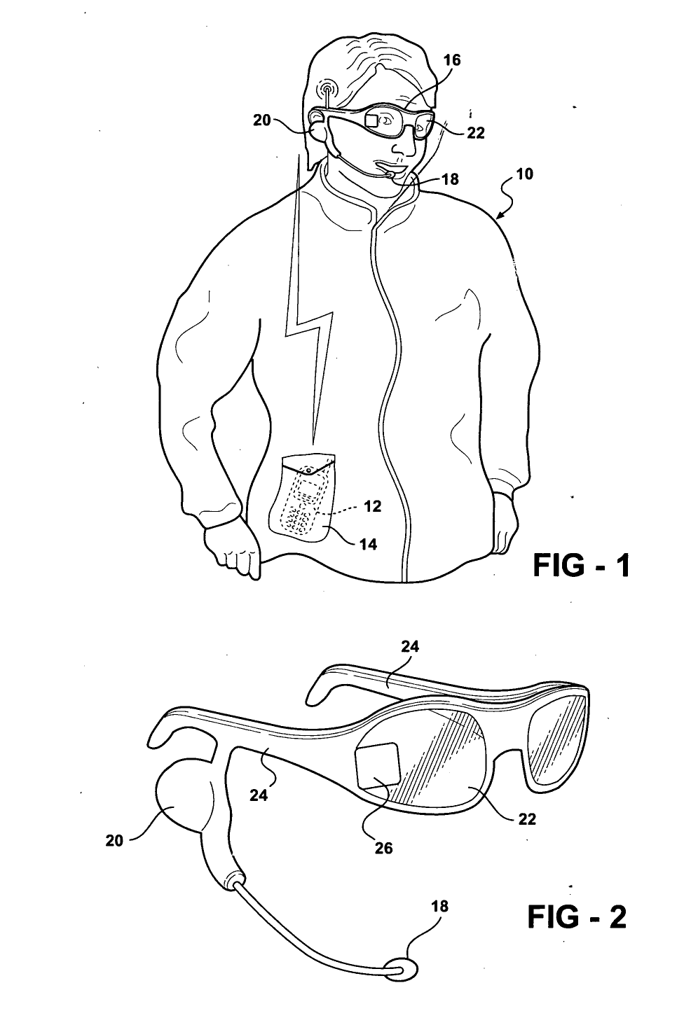

FIG. 1 illustrates a system of the present invention in use. The user, generally indicated at 10, has a cell phone, shown in phantom at 12, supported in a pocket 14. The cell phone includes a video display screen. The cell phone includes an RF communication system for communicating with a headset 16, supported on the user's ear. The headset includes a boom mike 18 and typically a sound conduction earpiece 20. The user is also wearing eyeglasses, generally indicated at 22, having conventional lenses and a frame with temple pieces 24. One of the temple pieces supports the receiver and transmitter and also supports a video screen 26 which is supported to one side of one of the lenses so that the user 10 can obtain conventional vision through the remaining portion of a lens.

A wired or wireless communication system between the cell phone 12 and the headset 16, such as Bluetooth and the like, allows the transmission of audio signals between the headset and the cellular phone and also allows transmission of the signals representative of the video screen of the cell phone 12 to the headset 16 for generation on the display 26. In an alternative embodiment of the invention, a small display may be physically supported on the headset, by the boom, which extends forwardly and slightly to the side of one of the user's eyes so that the user may observe the display screen on the headset with the lateral movement of the eyes, but the display does not interfere with the user's normal forward vision.

The wireless communication system between the cell phone and the headset may be unidirectional, transmitting only audio signals and display generating signals from the cell phone to the headset. Alternatively, the system may be bidirectional, also providing communication from the headset to the cell phone. In this version, the headset may be equipped with contact switches so that basic commands, such as on and off and the like, can be transmitted from the headset to the cell phone, allowing full use of the cell phone without hand contact to the phone itself. Buttons might include an up/down scroll button to allow shifting of the display screen, simple reply buttons, such as “yes” and “no,” “message received,” “I will reply later,” and the like.

Alternatively, the system could incorporate a voice command unit so that the user could control the operation of the cell phone through speech. The speech recognition hardware could be incorporated in either the headset or the cell phone. Thus, the operator might be able to turn on the system by saying “command on,” or the like, turn off the system by saying, “command off,” or the like, and use control terms such as “command next message,” or send textual messages by making oral statements which are translated by the voice recognition hardware into text statements which are then transmitted by the phone as SMS messages, or the like.

In an alternative embodiment to the invention, the headset display system may incorporate a small projector which projects the image of the screen onto either the one of the glasses of the user's eyeglasses or onto a small screen, which is preferably translucent, which forward and slightly to the side of the user's field of view. The screen may be controlled so as to be transparent when no display signal is being transmitted.

For example, the user may actuate appropriate buttons on the headset to get a display of the addresses contained within the phone, may view those on the headset 26 and may establish wireless communication to a desired address through the headset. In alternative embodiments the video image could be projected onto one of the lenses of the eyeglasses 22 rather than being supported on the video display 26. Other objects and advantages will be clear to one of ordinary skill in the art.

Having thus described my invention, I claim:

1. A cell phone system including:
a cell phone receiver with a video display;
a headset adapted to be supported on the head of a user and including a microphone, an earphone, and a video display supported relative to the use's eye; and
a wired or wireless communication between the cell phone and the headset allowing the transmission of audio signals between the microphone, earphone, headset and the transmission of signals representative of video display of the cell. phone for generation on the video display of the headset.

2. The cell phone system of claim 1, wherein the video display is supported on a pair of eyeglasses adapted to be worn by the user.

3. The cell phone system of claim 1, wherein the cell phone display is supported on the headset and by the boom extending into one point of the user's field of view so as to allow the user to see the display without obscuring the user's forward vision.

4. The cell phone system of claim 1, wherein the headset includes a mini-projector for projecting the display onto the user's eyeglasses.

5. The cell phone system of claim 1, wherein the headset incorporates a mini-projector for projecting the display onto a screen supported forward of the user's eyes and within the user's field of view.

6. The cell phone system of claim 5, wherein the screen is adapted to be controlled so as to be transparent when no display signal is being transmitted.

7. The cell phone system of claim 1, wherein the communication between the cell phone and the headset is bidirectional and the headset incorporates contact switches allowing signals to be transmitted from the headset to control the cell phone.

8. The system of claim 7, wherein the command signals include signals relative to SMS messages to be transmitted by the cell phone.

9. The system of claim 7, wherein the cell phone incorporates a speech recognition system allowing the user to control the cell phone and/or transmit SMS text messages via oral commands.
